(19) United States
(12) Patent Application Publication
(10) Pub. No.: US 2025/0031039 A1
(43) Pub. Date: Jan. 23, 2025

(54) AUTHENTICATION FOR A PROXIMITY-BASED SERVICE IN A WIRELESS COMMUNICATION NETWORK

(71) Applicant: TELEFONAKTIEBOLAGET LM ERICSSON (PUBL), STOCKHOLM (SE)

(72) Inventors: Zhang Fu, STOCKHOLM (SE); Monica Wifvesson, LUND (SE); Juying Gan, SHANGHAI (CN); Cheng Wang, SHANGHAI (CN); Qian Chen, MÖLNDAL (SE); David Castellanos Zamora, MADRID (ES)

(21) Appl. No.: 18/708,456

(22) PCT Filed: Oct. 18, 2022
(86) PCT No.: PCT/EP2022/078915

§ 371 Date: May 8, 2024

(30) Foreign Application Priority Data
Nov. 8, 2021 (WO) PCT/CN2021/129365

(51) Int. Cl. H04W 12/069; H04L 12/28; H04W 12/63; H04W 92/18

(52) U.S. Cl. CPC H04W 12/069; H04L 12/283; H04W 12/63; H04L 2012/2841; H04W 92/18

(57) ABSTRACT

A remote communication device performs an authentication procedure with a home communication network, via a relay communication device, to authenticate the remote communication device to the home communication network for a proximity-based service, ProSe. Performing the authentication procedure comprises deriving one or more keys included in an authentication vector. The remote communication device generates an anchor key for the ProSe directly from the one or more keys included in the authentication vector. The remote communication device protects ProSe direct communication between the remote communication device and the relay communication device using security key material derived from the anchor key.

### TECHNICAL FIELD

The present application relates generally to a wireless communication network, and relates more particularly to authentication for a proximity-based service (ProSe) in such a network.

### BACKGROUND

A proximity-based service (ProSe) is a service that enables communication devices in proximity of one another to communicate directly, i.e., via a path that does not traverse any network node. ProSe direct communication therefore is communication between communication devices in proximity, by means of user plane transmission via a path that does not traverse any network node.

ProSe can be used to extend the coverage of a communication network, e.g., for public safety services and/or commercial services. In this regard, a so-called relay communication device within the coverage of the communication network can relay traffic between the communication network and a so-called remote communication device outside the coverage of the communication network. The relay communication device in doing so effectively extends the coverage of the communication network to the remote communication device.

However, extending the existing authentication and security framework to handle this ProSe relaying use case would threaten and/or complicate the existing framework. Indeed, extending the existing framework in this way would require generating security keys for primary authentication of the remote communication device and would therefore negatively impact key handling at the network-side and the device-side. For example, in a 5G network, this would require generating a home network root key, Kausf, for primary authentication of the remote communication device according to the existing framework and then deriving an anchor key for ProSe from that home network root key. This would then impact handling of the home network root key and create dependencies on other features that are also based on the home network root key, such as User Equipment (UE) Parameter Update (UPU), Support of Optimal Routing (SOR), and/or Authentication and Key Management for Applications (AKMA).

### SUMMARY

Some embodiments herein authenticate the remote communication device for ProSe independent from and/or separate from primary authentication of the remote communication device. These and other embodiments herein may generate an anchor key for ProSe directly from one or more keys included in an authentication vector, e.g., rather than generating the anchor key for ProSe from a home network root key such as Kausf. Alternatively or additionally, some embodiments herein effectively cache the anchor key for ProSe in the serving network, for efficient re-use of the anchor key. Some embodiments herein thereby enable ProSe relaying while minimizing the impact on the existing authentication and security framework.

More particularly, embodiments herein include a method performed by a remote communication device. The method comprises performing an authentication procedure with a home communication network, via a relay communication device, to authenticate the remote communication device to the home communication network for a proximity-based service, ProSe. In this case, performing the authentication procedure comprises deriving one or more keys included in an authentication vector. The method also comprises generating an anchor key for the ProSe directly from the one or more keys included in the authentication vector, and protecting ProSe direct communication between the remote communication device and the relay communication device using security key material derived from the anchor key.

In some embodiments, the authentication vector is dedicated to the ProSe and/or the one or more keys included in the authentication vector are bound to the ProSe.

In some embodiments, deriving the one or more keys included in the authentication vector comprises deriving the one or more keys as a function of a relay service code and/or an identity of a serving communication network of the relay communication device.

In some embodiments, the one or more keys included in the authentication vector include a cipher key and an integrity key.

In some embodiments, the method further comprises deriving the security key material from the anchor key and a freshness parameter received from the relay communication device and/or a freshness parameter generated by the remote communication device.

In some embodiments, the anchor key is a PC5 anchor key K_{pc5} for a PC5 interface between the remote communication device and the relay communication device.

In some embodiments, the authentication procedure is performed as part of a connection establishment procedure for establishing a connection between the remote communication device and the relay communication device. In one or more of these embodiments, the method further comprises generating an identity that identifies the anchor key, identifies the security key material, or temporarily identifies the remote communication device, and after release of the connection, transmitting the identity to the same or a different relay communication device as part of a subsequent connection establishment procedure for establishing a new connection between the remote communication device and the same or a different relay communication device. The method further comprises, based on the identity, reusing the anchor key or the security key material for re-authentication of the remote communication device and/or for protecting ProSe direct communication over the new connection. In one or more of these embodiments, the method further comprises refraining from generating a home network root key as part of the authentication procedure and/or as part of the connection establishment procedure. In one or more of these embodiments, the home network root key is a key K_{AUSF}.

In some embodiments, the authentication procedure to authenticate the remote communication device to the home communication network for the ProSe is independent of and/or separate from a primary authentication procedure for primary authentication of the remote communication device to the home communication network.

In some embodiments, the method further comprises transmitting traffic to and/or receiving traffic from the home communication network via the ProSe direct communication between the remote communication device and the relay communication device.

In some embodiments, the relay communication device is a Layer-3 UE-to-Network Relay.

Other embodiments herein include a method performed by a home network node configured for use in a home communication network of a remote communication device. The method comprises receiving a request to authenticate the remote communication device to the home communication network for a proximity-based service, ProSe, performing an authentication procedure to authenticate the remote communication device according to the request, based on an authentication vector obtained for the remote communication device, generating an anchor key for the ProSe directly from one or more keys included in the authentication vector, and transmitting the anchor key in a response to the request.

In some embodiments, the authentication vector is dedicated to the ProSe and/or the one or more keys included in the authentication vector are bound to the ProSe.

In some embodiments, the one or more keys included in the authentication vector are a function of a relay service code and/or an identity of a serving communication network from which the request is received.

In some embodiments, the one or more keys included in the authentication vector include a cipher key and an integrity key.

In some embodiments, the anchor key is a PC5 anchor key K_{pc5} for a PC5 interface.

In some embodiments, the authentication procedure is performed as part of a connection establishment procedure for establishing a ProSe connection between the remote communication device and a relay communication device. In one or more of these embodiments, the method further comprises generating an identity that identifies the anchor key. In this case, the response also includes the identity. In one or more of these embodiments, the method further comprises refraining from generating a home network root key as part of the authentication procedure and/or as part of the connection establishment procedure. In one or more of these embodiments, the home network root key is a key K_{AUSF}.

In some embodiments, the authentication procedure to authenticate the remote communication device to the home communication network for the ProSe is independent of and/or separate from a primary authentication procedure for primary authentication of the remote communication device to the home communication network.

In some embodiments, the method further comprises obtaining the authentication vector by transmitting a request for the authentication vector to a subscription data management node in the home communication network, and receiving the authentication vector from the subscription data management node in response to the transmitted request. In one or more of these embodiments, the transmitted request indicates one or more of an identity associated with the remote communication device, a relay service code, or a serving network name of a serving communication network from which the request is received.

In some embodiments, the request is received from a serving network node in a serving communication network of a relay communication device that is to perform ProSe direct communication with the remote communication device as part of relaying traffic between the remote communication device and the home communication network. In one or more of these embodiments, the relay communication device is a Layer-3 UE-to-Network Relay.

In some embodiments, the request includes a subscription concealed identifier of the remote communication device. In this case, the method further comprises requesting de-concealment of the subscription concealed identifier in order to obtain a subscription permanent identifier of the remote communication device, and the response also includes the subscription permanent identifier.

Other embodiments herein include a method performed by a serving network node configured for use in a serving communication network of a relay communication device. The method comprises receiving, from the relay communication device, a key material request that requests security key material with which to protect proximity-based service, ProSe, direct communication between the relay communication device and a remote communication device, and responsive to the key material request, transmitting, to a home network node in a home communication network of the remote communication device, an authentication request that requests authentication of the remote communication device for the ProSe. The method further comprises receiving the anchor key in a response to the authentication request, generating the security key material from the anchor key, and transmitting the security key material to the relay communication device in a response to the key material request.

In some embodiments, the authentication request requests ProSe-specific authentication of the remote communication device for the ProSe.

In some embodiments, the anchor key is directly derived from one or more keys included in an authentication vector based on which the remote communication device is authenticated for the ProSe. In one or more of these embodiments, the authentication vector is dedicated to the ProSe and/or the one or more keys included in the authentication vector are bound to the ProSe. In one or more of these embodiments, the one or more keys included in the authentication vector are a function of a relay service code and/or an identity of the serving communication network. In one or more of these embodiments, the one or more keys included in the authentication vector include a cipher key and an integrity key.

In some embodiments, the anchor key is a PC5 anchor key K_{pc5} for a PC5 interface between the remote communication device and the relay communication device.

In some embodiments, the relay communication device is a Layer-3 UE-to-Network Relay.

In some embodiments, generating the security key material comprises generating a freshness parameter and deriving the security key material from the anchor key and the freshness parameter. In one or more of these embodiments, the method further comprises transmitting the freshness parameter to the relay communication device.

In some embodiments, the method further comprises storing the anchor key in local storage that is local to the serving network node. In one or more of these embodiments, the method further comprises, after transmitting the security key material to the relay communication device, receiving a subsequent key material request that requests security key material with which to protect ProSe direct communication between the remote communication device and the same or a different relay communication device, and responsive to the subsequent key material request, retrieving the anchor key from the local storage. The method further comprises deriving new security key material from the anchor key, and transmitting the new security key material in a response to the subsequent key material request. In one or more of these embodiments, the method further comprises generating an identity that identifies the anchor key, identifies the security key material, or temporarily identifies the remote communication device, and storing the anchor key in the local storage in association with the identity. In this case, the subsequent key material request includes the identity, and the anchor key is retrieved from the local storage using the identity included in the subsequent key material request.

In some embodiments, the method further comprises generating an identity that identifies the anchor key, identifies the security key material, or temporarily identifies the remote communication device, and storing the anchor key in the local storage in association with the identity. In one or more of these embodiments, storing the anchor key comprises storing the anchor key in a context for the relay communication device or in a ProSe-specific context for the remote communication device.

Other embodiments herein include a method performed by a subscription data management node configured for use in a home communication network of a remote communication device. The method comprises receiving, from a home network node in the home communication network, a request for an authentication vector based on which to authenticate a remote communication device to the home communication network for a proximity-based service, ProSe, generating the requested authentication vector, and transmitting the authentication vector to the home network node in a response to the request.

In some embodiments, the request indicates one or more parameters. In this case, generating the authentication vector comprises generating the authenticated vector based on the one or more parameters, and the one or more parameters include one or more of an identity associated with the remote communication device, a relay service code, a serving network name of a serving communication network serving a relay communication device that is to perform ProSe direct communication with the remote communication device as part of relaying traffic between the remote communication device and the home communication network.

In some embodiments, the method further comprises assigning a sequence number of the authentication vector specific to the ProSe.

In some embodiments, the authentication vector is dedicated to the ProSe and/or one or more keys included in the authentication vector are bound to the ProSe.

In some embodiments, one or more keys included in the authentication vector are a function of a relay service code and/or an identity of a serving communication network serving a relay communication device that is to perform ProSe direct communication with the remote communication device as part of relaying traffic between the remote communication device and the home communication network.

Other embodiments herein include corresponding apparatus, computer programs, and carriers of those computer programs.

### BRIEF DESCRIPTION OF THE DRAWINGS

FIG. 1 is a block diagram of a remote communication device and a relay communication device for ProSe relaying in accordance with some embodiments.

FIG. 2 is a call flow diagram for ProSe relaying according to some embodiments.

FIGS. 3A and 3B are call flow diagrams for authentication and protection for ProSe relaying according to some embodiments.

FIG. 4 is a logic flow diagram of a method performed by a remote communication device according to some embodiments.

FIG. 5 is a logic flow diagram of a method performed by a home network node according to some embodiments.

FIG. 6 is a logic flow diagram of a method performed by a serving network node according to some embodiments.

FIG. 7 is a logic flow diagram of a method performed by a subscription data management node according to some embodiments.

FIG. 8 is a block diagram of a remote communication device according to some embodiments.

FIG. 9 is a block diagram of a network node according to some embodiments.

FIG. 10 is a block diagram of a communication system in accordance with some embodiments

FIG. 11 is a block diagram of a user equipment according to some embodiments.

FIG. 12 is a block diagram of a network node according to some embodiments.

FIG. 13 is a block diagram of a host according to some embodiments.

FIG. 14 is a block diagram of a virtualization environment according to some embodiments.

FIG. 15 is a block diagram of a host communicating via a network node with a UE over a partially wireless connection in accordance with some embodiments.

### DETAILED DESCRIPTION

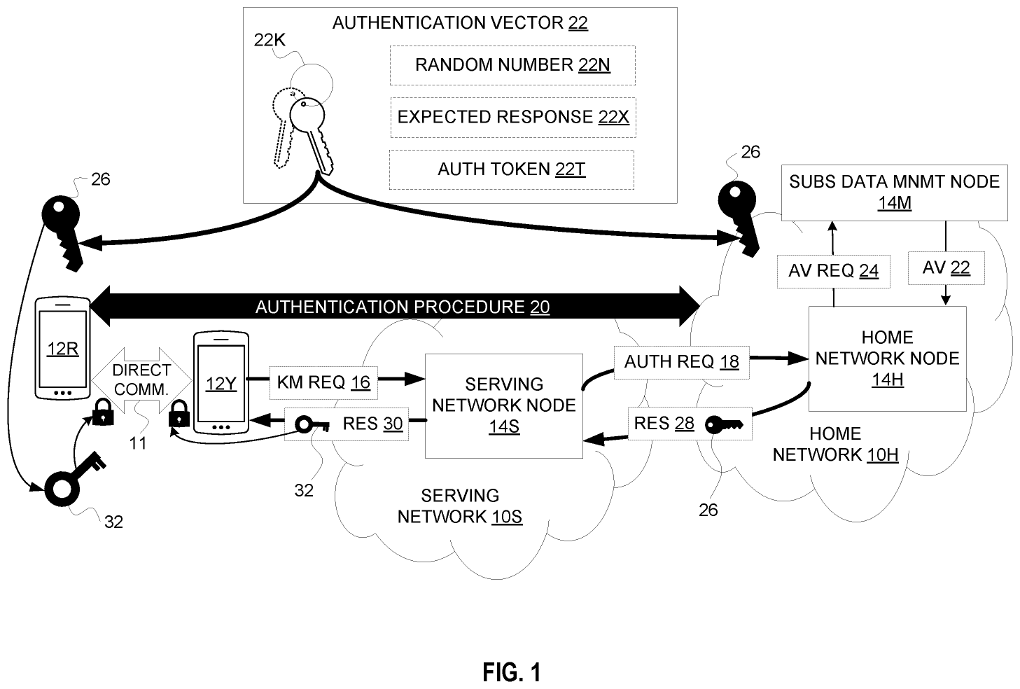

FIG. 1 shows one or more embodiments for authenticating a remote communication device 12R for a proximity-based service (ProSe) and for protecting ProSe direct communication 11 between the remote communication device 12R and a relay communication device 12Y. The communication devices 12R, 12Y in this regard are in proximity of one another, e.g., in communication range of one another. The ProSe is a service that enables the communication devices 12R, 12Y in proximity of one another to communicate directly, i.e., via a path that does not traverse any network node. ProSe direct communication 11 therefore is communication between the communication devices 12R, 12Y by means of user plane transmission via a path that does not traverse any network node.

The ProSe direct communication 11 as shown in FIG. 1 is used for ProSe relaying, to extend communication network coverage, e.g., for public safety services and/or commercial services. In this regard, the remote communication device 12R is outside of network coverage, e.g., outside the coverage of the remote communication device's home communication network 10H and outside the coverage of any visited network with which the home communication network 10H may have a roaming agreement. However, the relay communication device 12Y is within coverage of a serving communication network 10S, which may be the same as the home communication network 10H or may be a visited network with which the home communication network 10H has a roaming agreement. The relay communication device 12Y accordingly relays traffic between the remote communication device 12R and the remote communication device's home network 10H, to effectively extend the communication network coverage to the remote communication device 12R. That is, the relay communication device 12Y transmits traffic to and/or receives traffic from the remote communication device 12R via ProSe direct communication 11, and transmits traffic to and/or receives traffic from the home communication network 10H via its communication interface with the serving communication network 10S. As one example, the relay communication device 12Y may be a Layer-3 UE-to-Network Relay as described herein.

In any event, the remote communication device 12R may initiate establishment of a connection with the relay communication device 12Y, e.g., after discovery of the relay communication device 12Y. As part of establishing such a connection, the relay communication device 12Y as shown transmits a key material request 16 to a serving network node 14S (e.g., implementing an Access and Mobility Function, AMF) in a serving communication network 10S serving the relay communication device 12Y. The key material request 16 requests security key material with which to protect ProSe direct communication 11 between the relay communication device 12Y and the remote communication device 12R.

Responsive to the key material request 16, the serving network node 14S transmits an authentication request 18 to a home network node 14H (e.g., implementing an Authentication Server Function, AUSF) in the remote communication device's home communication network 10H. The authentication request 18 requests authentication of the remote communication device 12R for the ProSe, e.g., where the requested authentication may be ProSe-specific authentication and/or be separate or independent from primary authentication of the remote communication device 12R.

The authentication request 18 according to some embodiments triggers an authentication procedure 20 between the remote communication device 12R and the home communication network 10H, for authenticating the remote communication device 12R for the ProSe. The authentication procedure 20 in some embodiments is specific for the ProSe and/or is separate from or independent from a primary authentication procedure. Regardless, the authentication procedure 20 may enable authentication of the remote communication device 12R to the home communication network 10H and optionally also authentication of the home communication network 10H to the remote communication device 12R. The authentication procedure 20 may also provide key material that can be used in subsequent security procedures.

Specifically, authentication of the remote communication device 12R for the ProSe as shown is based on an authentication vector 22, e.g., where the authentication vector 22 is valid for use in a single run of the authentication procedure 20 so as to prevent its re-use. The authentication vector 22 includes one or more keys 22K, e.g., a cipher key and/or an integrity key. In some embodiments, the authentication vector 22 further includes a random number 22N, an expected response 22X, and/or an authentication token 22T. In embodiments based on a 3GPP network, for instance, the random number 22N may be a RAND, the expected response 22X may be an XRES, and/or the authentication token 22T may be an AUTN.

In some embodiments, the authentication vector 22 is generic so as not to be specific to any certain service or use, e.g., the authentication vector 22 is usable for either primary authentication or for ProSe authentication. In this case, the key(s) 22K may include a cipher key denoted as CK and an integrity key denoted as IK. In other embodiments, by contrast, the authentication vector 22 is dedicated to the ProSe and/or the key(s) 22K are bound to the ProSe. In this case, the ProSe-specific authentication vector 22 may be a transformed version of a generic authentication vector (not shown), e.g., whereby the generic authentication vector is transformed to be specific to ProSe. In some embodiments, for example, the key(s) 22 may be derived as a function of a relay service code and/or an identity of the serving communication network 10S. In one embodiment, then, the key(s) 22 may include a cipher key denoted as CK′ and an integrity key denoted as IK′.

In any event, in some embodiments, the authentication request 18 from the serving network node 14S triggers the home network node 14H to transmit an authentication vector (AV) request 24 to a subscription data management node 14M in the home communication network 10H. The AV request 24 requests an authentication vector 22 based on which to authenticate the remote communication device 12R to the home communication network 10H for the ProSe. In some embodiments, the AV request 24 indicates one or more parameters, e.g., an identity associated with the remote communication device 12R, a relay service code, and/or a serving network name of the serving communication network 10S.

The subscription data management node 14M generates the authentication vector 22 responsive to the AV request 24, e.g., based on the parameter(s) in the AV request 24. The subscription data management node 14M then transmits the AV 22 to the home network node 14H in a response to the request 24.

The home network node 14H performs the authentication procedure 20 based on the AV 22. For example, in one embodiment, as part of the authentication procedure 20, the home network node 14H transmits the random number 22N and the authentication token 22T towards the remote communication device 12R. The remote communication device 12R generates a response (not shown) as a function of the random number 22N, the authentication token 22T, and a shared key, and transmits that response back. The remote communication device 12 is then authenticated for the ProSe if the returned response corresponds to (e.g., matches) the expected response 22X in the authentication vector 22. As part of or after the authentication procedure 20, the remote communication device 12R also itself derives the key(s) 22K in the authentication vector 22, e.g., as a function of the random number 22N and/or the authentication token 22T.

As a result of or in association with the authentication procedure 20, then, both the remote communication device 12R and the home network node 14H are equipped with the key(s) 22K included in the authentication vector 22. The remote communication device 12R and the home network node 14 each separately generate an anchor key 26 for the ProSe from the key(s) 22K included in the authentication vector 22. The anchor key 26 for the ProSe is an anchor key in the sense that key material for more than one security context can be derived from the anchor key 26 without the need of another run of the authentication procedure 20. In one embodiment, for example, where the communication devices 12R, 12Y directly communicate over a PC5 interface, the anchor key 26 may be referred to as a PC5 anchor key K_{pc5}.

Notably, according to some embodiments herein, the remote communication device 12R and the home network node 14 each generate the anchor key 26 for the ProSe directly from the key(s) 22K included in the authentication vector 22. In one embodiment, generating the anchor key 26 directly from the key(s) 22K means that the anchor key 26 directly descends from the key(s) 22K in a key hierarchy, without any intervening key in between the anchor key 26 and the key(s) 22K. Accordingly, rather than generating a home network root key (e.g., Kausf) directly from the key(s) 22K and then generating the anchor key 26 directly from the home network root key, so as to generate the anchor key 26 only indirectly from the key(s) 22K, the remote communication device 12R and the home network node 14H each generate the anchor key 26 directly from the key(s) 22K in the authentication vector 22. This may mean, then, that neither the remote communication device 12R nor the home network node 14H need generate such a home network root key (e.g., Kausf) as part of the authentication procedure 18 for ProSe. Indeed, in some embodiments, the remote communication device 12R and the home network node 14H each refrain from generating the home network root key as part of the authentication procedure 20 and/or as part of the connection establishment procedure between the communication devices 12R, 12Y. Some embodiments thereby advantageously minimize the impact of ProSe relaying on handling of the home network root key and/or avoid creating dependencies of ProSe on other features that are also based on the home network root key, such as User Equipment (UE) Parameter Update (UPU), Support of Optimal Routing (SOR), and/or Authentication and Key Management for Applications (AKMA).

Having generated the anchor key 26 in this way, the home network node 14H transmits the anchor key 26 in a response 30 to the authentication request 18. The serving network node 14S correspondingly receives the anchor key 26 in the response 30. The serving network node 14S then uses the anchor key 26 to generate the security key material requested by the key material request 16. The serving network node 14S in this regard generates security key material 32 from the anchor key 26. In one embodiment where the communication devices 12R, 12Y directly communicate over a PC5 interface, the security key material 32 may be referred to as PC5 communication key material (Kpc5-com). Regardless, in some embodiments, the serving network node 14S generates the security key material 32 also from one or more freshness parameters, e.g., by generating a freshness parameter at the serving network node 14S and generating the security key material 32 also from that generated freshness parameter. As one example, such a freshness parameter may be a random number, e.g., in the form of a Kpc5-com Freshness Parameter. In any event, the serving network node 14S then transmits the security key material 32 to the relay communication device 12Y in a response 30 to the key material request 16.

Correspondingly, the remote communication device 12R separately generates the security key material 32 from the anchor key 26. Although not shown, for instance, the serving network node 12S may also transmit the freshness parameter to the relay communication device 12Y, which in turn transmits the freshness parameter to the remote communication device 12R. The remote communication device 12R may then generate the security key material 32 from the anchor key 26 and the received freshness parameter.

By way of the above, then, both the remote communication device 12R and the relay communication device 12Y obtain the security key material 32 for protecting the ProSe direct communication 11. Accordingly, the remote communication device 12R and the relay communication device 12Y protect the ProSe direct communication 11 using the security key material 32 derived from the anchor key 26. With the ProSe direct communication 11 protected in this way, the remote communication device 12R may advantageously transmit traffic to and/or receive traffic from the home communication network 10H via the ProSe direct communication 11.

Alternatively or additionally, some embodiments herein effectively cache the anchor key 26 for ProSe in the serving network node 14S, e.g., for efficient re-use of the anchor key 26. In some embodiments, for example, the serving network node 14S stores the anchor key 26, e.g., in local storage that is local to the serving network node 14S. For example, the serving network node 12S may store the anchor key 26 in a context for the relay communication device 12Y or in a ProSe-specific context for the remote communication device 12R. Regardless, in some embodiments, the serving network node 14S may generate an identity that identifies the anchor key 26, identifies the security key material 32, or temporarily identifies the remote communication device 12R. The serving network node 14S in this case may store the anchor key 26 (e.g., in the local storage) in association with this identity, e.g., for later retrieval using the identity.

For example, after transmitting the security key material 32 to the relay communication device 12Y, the serving network node 14S may receive a subsequent key material request (not shown) that requests security key material with which to protect ProSe direct communication between the remote communication device 12R and the same or a different relay communication device. Having effectively cached the anchor key 26 for the remote communication device 12R, the serving network node 14S may re-use the anchor key 26 for generating the requested security key material. Responsive to the subsequent key material request in this regard, the serving network node 14S may retrieve the anchor key 26 (from the local storage), derive new security key material from the anchor key 26, and transmit the new security key material in a response to the subsequent key material request. In fact, in some embodiments, the subsequent key material request includes the identity, in which case the serving network node 14S retrieves the anchor key 26 from the local storage using the identity included in the subsequent key material request.

Some embodiments herein are applicable in the following 5G context, in which the remote communication device 12R is exemplified as a remote user equipment (UE), the relay communication device 12Y is exemplified as a Layer-3 UE-to-Network Relay, the serving network node 14S is exemplified as an AMF serving the Layer-3 UE-to-Network Relay, the home network node 14H is exemplified as an AUSF for the remote UE, the ProSe direct communication 11 is exemplified as occurring over a PC5 interface between the communication devices 12R, 12Y, the anchor key 26 is exemplified as a PC5 anchor key K_{pc5}, and the key(s) 22K in the authentication vector 22 are exemplified as either a cipher key CK and an integrity key IK or a transformed cipher key CK′ and a transformed integrity key IK′.

### Layer-3 UE-to-Network Relay in 5G ProSe

Some embodiments are applicable to Layer-3 UE-to-Network Relay in 5GS as described in TS 23.304 v17.0.0. A 5G ProSe Layer-3 UE-to-Network Relay registers to the network (if not already registered). 5G ProSe Layer-3 UE-to-Network Relay establishes a Protocol Data Unit (PDU) Session(s) or modifies an existing PDU Session(s) in order to provide relay traffic towards 5G ProSe Layer-3 Remote UE(s). PDU Session(s) supporting 5G ProSe Layer-3 UE-to-Network Relay shall only be used for 5G ProSe Layer-3 Remote UE(s) relay traffic.

The Public Land Mobile Network (PLMN) serving the 5G ProSe Layer-3 UE-to-Network Relay and the PLMN to which the 5G ProSe Layer-3 Remote UE registers can be the same PLMN or two different PLMNs.

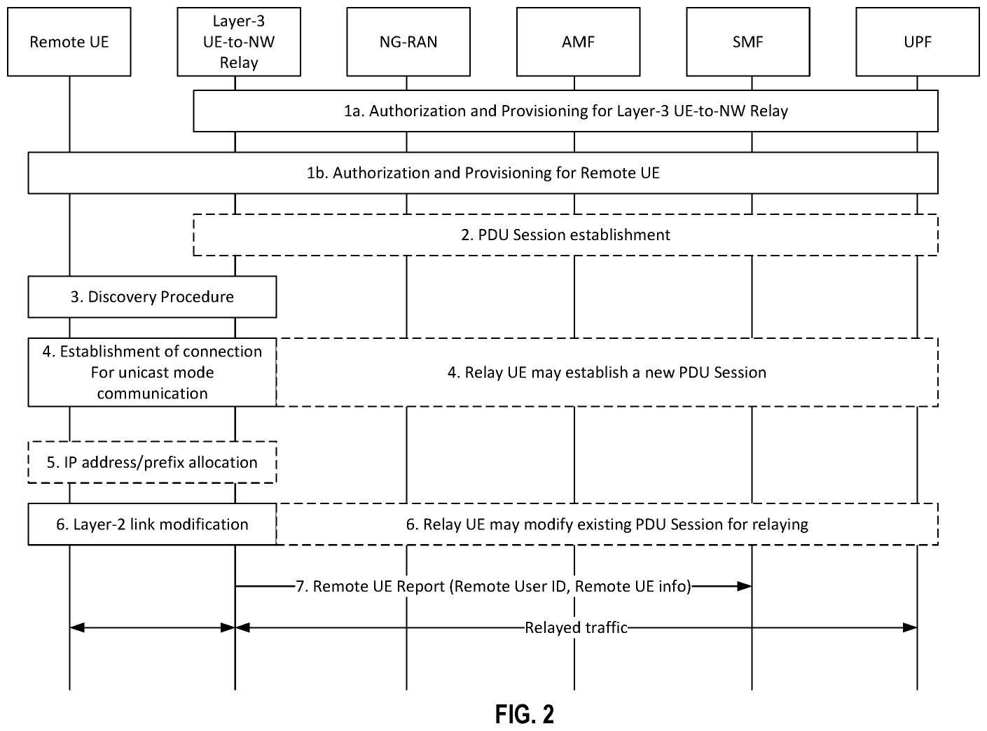

FIG. 2 shows 5G ProSe Communication via 5G ProSe Layer-3 UE-to-Network Relay without N3IWF according to some embodiments.
1. Service authorization and provisioning are performed for the 5G ProSe Layer-3 UE-to-Network Relay (step 1a) and 5G ProSe Layer-3 Remote UE (step 1b).
2. The 5G ProSe Layer-3 UE-to-Network Relay may establish a PDU Session for relaying. In case of IPV6, the 5G ProSe Layer-3 UE-to-Network Relay obtains the IPV6 prefix via prefix delegation function from the network as defined in TS 23.501 v. 17.2.0.
   NOTE 1: 5G ProSe Layer-3 UE-to-Network Relay can establish a PDU Session for any Relay Service Code it supports before the connection is established with the 5G ProSe Layer-3 Remote UE.
3. The 5G ProSe Layer-3 Remote UE performs discovery of a 5G ProSe Layer-3 UE-to-Network Relay. As part of the discovery procedure the 5G ProSe Layer-3 Remote UE learns about the connectivity service the 5G ProSe Layer-3 UE-to-Network Relay provides.
4. The 5G ProSe Layer-3 Remote UE selects a 5G ProSe Layer-3 UE-to-Network Relay and establishes a connection for unicast mode communication. If there is no PDU Session associated with the Relay Service Code or a new PDU Session for relaying is needed, the 5G ProSe Layer-3 UE-to-Network Relay initiates a new PDU Session establishment procedure for relaying before completing the PC5 connection establishment.
   The 5G ProSe Layer-3 UE-to-Network Relay determines the PDU Session type for relaying.
   According to the PDU Session Type for relaying, the 5G ProSe Layer-3 UE-to-Network Relay performs relaying function at the corresponding layer as follows:
   When the IP type PDU Session is used for IP traffic over PC5 reference point, the 5G ProSe Layer-3 UE-to-Network Relay acts as an IP router. For IPV4, the 5G ProSe Layer-3 UE-to-Network Relay performs IPv4 NAT between IPv4 addresses assigned to the 5G ProSe Layer-3 Remote UE and the IPV4 address assigned to the PDU Session used for the relay traffic.
   When the Ethernet type PDU Session is used for Ethernet traffic over PC5 reference point, the 5G ProSe Layer-3 UE-to-Network Relay acts as an Ethernet switch.
   When the Unstructured type PDU Session is used for Unstructured traffic over PC5 reference point, the 5G ProSe Layer-3 UE-to-Network Relay performs traffic relaying based on a mapping between the PC5 Link Identifier and the PDU Session ID, and a mapping between PFI for PC5 Layer-2 link and the QFI for the PDU Session. These mappings are created when the Unstructured type PDU Session is established for the 5G ProSe Layer-3 Remote UE.
   When the IP type PDU Session is used for Ethernet or Unstructured traffic over PC5 reference point, the 5G ProSe Layer-3 UE-to-Network Relay uses IP tunneling. For this IP tunnelling, the 5G ProSe Layer-3 UE-to-Network Relay locally assigns an IP address/prefix for the 5G ProSe Layer-3 Remote UE and uses it on the Uu reference point to encapsulate and decapsulate the uplink and downlink traffic for the 5G ProSe Layer-3 Remote UE. The tunnelled traffic over Uu reference point is transported over the PC5 reference point as Ethernet or Unstructured traffic.
5. For IP PDU Session Type and IP traffic over PC5 reference point, IPv6 prefix or IPv4 address (including NAT case) is allocated for the 5G ProSe Layer-3 Remote UE.
6. The 5G ProSe Layer-3 Remote UE may provide the PC5 QoS rule to the 5G ProSe Layer-3 UE-to-Network Relay using Layer-2 link modification procedure. The 5G ProSe Layer-3 UE-to-Network Relay generates the Packet Filters used over Uu interface based on the received PC5 QoS Rule(s), and may perform the UE requested PDU Session Modification to setup a new QoS Flow or bind the traffic to an existing QoS Flow.
   From this point the uplink and downlink relaying can start. For downlink traffic forwarding, the PC5 QoS Rule is used to map the downlink packet to the PC5 QoS Flow. For uplink traffic forwarding, the 5G QoS Rule is used to map the uplink packet to the Uu QoS Flow.
7. The 5G ProSe Layer-3 UE-to-Network Relay shall send a Remote UE Report (Remote User ID, Remote UE info) message to the SMF for the PDU Session associated with the relay. The Remote User ID is an identity of the 5G ProSe Layer-3 Remote UE user (provided via User Info) that was successfully connected in step 4. The Remote UE info is used to assist identifying the 5G ProSe Layer-3 Remote UE in the 5GC. For IP PDU Session Type, the Remote UE info is Remote UE IP info. For Ethernet PDU Session Type, the Remote UE info is Remote UE MAC address which is detected by the 5G ProSe Layer-3 UE-to-Network Relay. For Unstructured PDU Session Type, the Remote UE info is not included. The SMF stores the Remote User IDs and the related Remote UE info in the 5G ProSe Layer-3 UE-to-Network Relay's SM context for this PDU Session associated with the relay.
   The Remote UE Report is N1 SM NAS message sent with the PDU Session ID to the AMF, in turn delivered to the SMF.

### Security for Layer-3 UE-to-Network Relay in 5G ProSe

Some embodiments secure PC5 communication to support Layer-3 UE-to-Network Relay consistent with 5GS TR 33.847 v0.8.0. There are two categories of solutions proposed, one is user plane (UP) based solution, the other is control plane (CP) based solution.

For CP based solution, for PC5 link security, PC5 keys are derived using keys derived from the primary authentication. The security of the communication between UE-to-Network relay and remote UE is established based on a shared key which is derived and distributed with the assistance of the network. A root credential is configured in the remote UE and the network. The shared key is individually derived from the root credential by the remote UE and the network. The shared key is distributed by the AMF to the UE-to-Network relay. AUSF derives the PC5 anchor key used for PC5 keys derivation.

In some embodiments, authorization for Remote UE/Relay is based on primary authentication and using PCF based service authorization and provisioning as defined in TS 23.304 (v. 17.0.0) clause 5.1.4. Performing primary authentication during PC5 link establishment is supported.

Existing network entities (AMF, AUSF, UDM) are used for key derivation and distribution of keys used for UE-to-network relay communication. The security of the communication between UE-to-Network relay and remote UE is established based on a shared key which is derived and distributed with the assistance of the network. A root credential is configured in the remote UE and the network. The shared key is individually derived from the root credential by the remote UE and the network. The shared key is distributed by the AMF to the UE-to-Network relay. AUSF derives the PC5 anchor key used for PC5 keys derivation.

Some embodiments herein address certain challenge(s) in this context. It is heretofore unclear whether Kausf is generated for the remote UE authentication performed during PC5 link establishment and used as root key for PC5 anchor key. Apparently, if the remote UE authentication performed during PC5 link establishment would result to Kausf generation, it would bring potential additional impacts in network side and UE side for Kausf key handling and dependency to other features based on Kausf, e.g., UPU/SOR, AKMA.

Certain aspects of the disclosure and their embodiments may provide solutions to these or other challenges. It is desirable a target CP solution for Prose should be loosely coupled with the UE's primary authentication and key hierarchy handling for 3GPP access.

Therefore, it is proposed that,
UE authentication performed authentication during PC5 link establishment is independent to the UE's primary authentication of 3GPP access and there is no need to generate Kausf.
AUSF derives the PC5 anchor key (Kpc5; Also known as PRUK, ProSe Relay User Key) based on the authentication vectors retrieved for UE authentication performed during PC5 link establishment.
Kpc5 and Kpc5 Key ID is generated by AUSF and be delivered & managed in AMF;
   Alternatively, Kpc5 Key ID is not generated but a temporary ID is generated by AMF to link with Kpc5 received from AUSF.
Certain embodiments may provide one or more of the following technical advantage(s).
1. Kausf handling of UE primary authentication is not impacted by the authentication for Prose traffic
2. Kpc5 is stored in relay AMF locally to enable fast further key derivation based on Kpc5
3. Kpc5 ID is maintained by AMF to enable fast re-authentication from remote UE based on Kpc5 ID

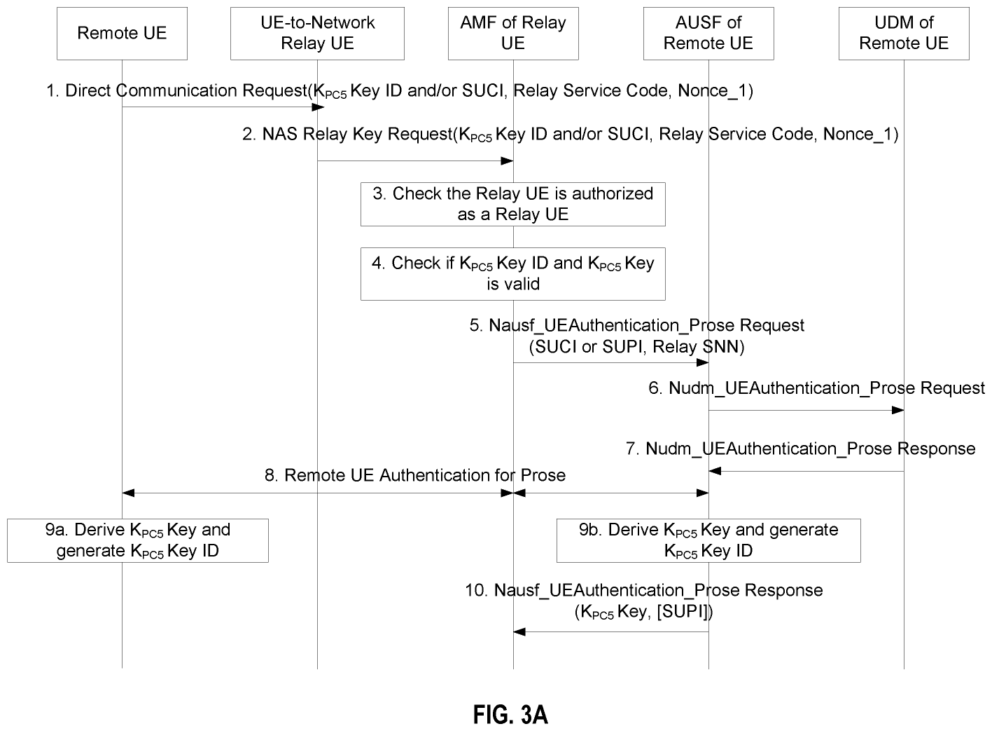

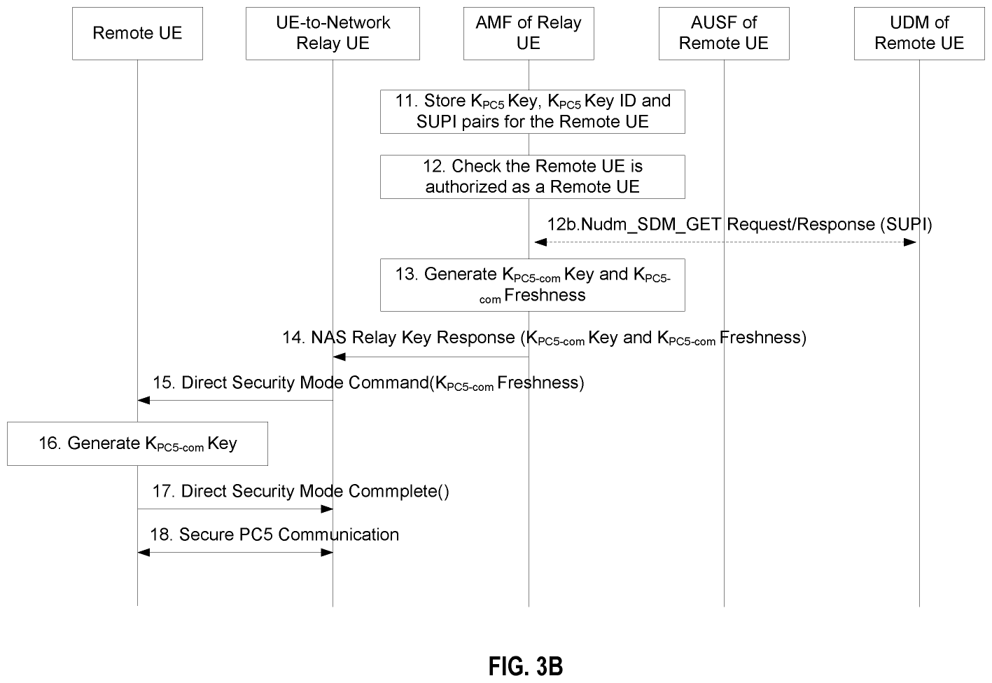

FIGS. 3A and 3B show one example for ProSe relaying according to some embodiments.

The text marked with italics is considered new to existing CP based solution.

With reference to FIGS. 3A and 3B, the UE-to-network relay security flow based on UE authentication is described as follows:
1. The Remote UE generates a freshness parameter Nonce_1 for the one-to-one communication and sends a Direct Communication Request to the Relay UE. In addition to the one-to-one communication parameters, the message may contain the following parameters:
a Relay Service Code that the Remote UE would like to access.
a Kpc5 Key ID (if the Remote UE has a Kpc5 already)
a SUCI (if the Remote UE does not have a valid a Kpc5 already key ID).
NOTE 1: Kpc5 and Kpc5 Key ID are equivalent to PRUK and PRUK ID in TS 33.303 v 16.0.0, respectively.
2. The Relay UE sends a NAS Relay Key Request to its serving AMF. The message includes the parameters received from the Remote UE, i.e. Kpc5 Key ID and/or SUCI, Relay Service Code and Nonce_1.
3. The AMF of the Relay UE checks whether the Relay UE is authorized to be a Relay UE according to the Relay Service Code. The relay service authorization information is stored in the UDM of the Relay UE.
4. The AMF of relay checks if Kpc5 Key ID and the Kpc5 pointed by Kpc5 Key ID are valid and available locally. If Kpc5 and Kpc5 Key ID are valid, the AMF goes to step 12.
5. If Kpc5 Key ID and the Kpc5 pointed by Kpc5 Key ID are not valid or not available locally or the AMF determines the Kpc5 need to be refreshed, the AMF of the Relay UE sends authentication request for UE Prose service, e.g. via a new message Nausf_UEAuthentication_Prose Request or updated of existing message Nausf_UEAuthentication_authenticate with a ProSe authentication flag, to the AUSF of the Remote UE. The message includes Remote UE's SUCI or SUPI, Relay Service Code, Serving Network Name of relay network.
6-7. The AUSF sends a request for authentication vector of the Remote UE for Prose service e.g. via a new message Nudm_UEAuthentication_GetProseAV or update of existing message Nudm_UEAuthentication_Get with a ProSe authentication flag, to the UDM of the Remote UE. The message includes Remote UE's SUCI or SUPI, Relay Service Code, Serving Network Name of relay network.
   The UDM de-conceal SUCI to SUPI; the UDM retrieves the authentication credential for the remote UE based on the SUPI. The UDM generates the authentication vector for Prose service, with input of Relay Service Code, Serving Network Name of relay network. The UDM may assign a specific SQN of the authentication vector for Prose service; The UDM responses to the AUSF with SUPI, authentication vector for Prose service, e.g. via message Nudm_UEAuthentication_GetProseAV Response.
8. The AUSF of the Remote UE performs an UE authentication procedure for Prose service to the remote UE through the Relay UE based on the received authentication vector for Prose service.
9. If authentication is successful, the Remote UE and the AUSF generates Kpc5 and Kpc5 Key ID based on the authentication vector for Prose service
10. The AUSF of the Remote UE sends Kpc5, Kpc5 Key ID and SUPI of the remote UE to the AMF of the Relay UE.
11. The AMF of the Relay UE stores Kpc5, Kpc5 Key ID and SUPI of the remote UE as part of the UE context of Relay UE.
12. The AMF of the Relay UE checks whether the remote UE is authorized as remote UE, based on SUPI of remote UE and the subscription data of the remote UE, e.g. the AMF of the Relay UE may get remote UE's subscription data from the UDM of the remote UE via Nudm_SDM_GET request/response with the remote UE's UE ID i.e. SUPI in the message.
13. The AMF of the Relay UE generates PC5 communication key material (Kpc5-com), e.g. a new random number as the Kpc5-com Freshness Parameter, and then generates a new Kpc5-com using Kpc5, Kpc5-com Freshness Parameter, Nonce_1, Relay Service Code, etc.
NOTE 3: Kpc5-com is equivalent to K_{D} in TS 33.303.
14. The AMF of the Relay UE sends Kpc5-com, Kpc5-com Freshness to the Relay UE.
15. The Relay UE sends a Direct Security Mode Command to the Remote UE. In addition to one-to-one communication parameters, the message includes Kpc5-com Freshness Parameter.
16. The Remote UE generates PC5 communication key material Kpc5-com using Kpc5, Kpc5-com Freshness Parameter, Nonce_1, Relay Service Code, etc.
17. The Remote UE sends Direct Security Mode Complete message to Relay UE.
18. The PC5 communication security is set up between the Remote UE and the Relay UE.

Alternatively, in other embodiments, FIGS. 3A and 3B may be modified as follows:
Step 1-4, Instead of Kpc5 Key ID, a temporary UE Identity e.g. Pr-GUTI (Prose GUTI) for the remote UE is used
Step 9, the Remote UE and the AUSF does not generate Kpc5 Key ID
Step 10, the AUSF does not send Kpc5 Key ID
Step 11, Instead of storing Kpc5 Key ID, the AMF generates a Pr-GUTI for the UE.
Step 14-15, Pr-GUTI is sent to the Remote UE and stored.

Alternatively, in still other embodiments, FIGS. 3A and 3B may be modified as follows:
Step 1-4, Instead of Kpc5 Key ID, a Kpc5-com Key ID is used
Step 9, the Remote UE and the AUSF does not generate Kpc5 Key ID
Step 10-11, the AUSF does not send Kpc5 Key ID to the AMF
Step 13, the AMF generates additionally a Kpc-com Key ID, and store the key material (Kpc5 Key, SUPI, Kpc5-com, Kpc5-com Key ID)
Step 16, the UE generates additionally a Kpc-com Key ID, and store the key material.

Alternatively, in still other embodiments, FIGS. 3A and 3B may be modified as follows:
Step 11, Instead of storing Kpc5 Key material of remote UE in the relay UE context, the AMF of the relay UE creates a UE context for ProSe service and store Kpc5 Key material of remote UE in this context; The AMF may use Kpc5 Key ID in clause 6.1 or pr-GUTI in clause 6.2 or Kpc-com Key ID in cause 6.3 to identify this UE context for the remote UE.

In some embodiments, 5G-GUTI handling for remote UE is tightly linked with UE's context handling, which is owned by it serving AMF, e.g. mobility handling, registration handling etc. According to some embodiments, the remote UE's serving AMF should not be impacted on the UE context handling or 5G-GUTI handling for L3 U2N relay. Thus, there is no need for the relay AMF to assign/maintain/refresh 5G-GUTI of Remote UE in L3 U2N solution.

Some embodiments herein may be described as addressing a key issue of security of UE-to-Network Relay. Specifically, the solutions for U2N Relay authorization and security can be classified as user-plane (UP) or controlled-plane (CP) based solutions. The UP based solutions use a UP connection to an AF (PKMF) while CP based solutions use the primary authentication for PC5 keys establishment. Both control plane and user plane solutions are supported for L3 U2N relay.

In some embodiments, the following text is taken as conclusions for UE-to-Network Relay solution. For the control plane solution, the following conclusion is made:

For PC5 link security, PC5 keys are derived using keys derived from the primary authentication (e.g., sol #1, #10, #15, #30). The security of the communication between UE-to-Network relay and remote UE is established based on a shared key which is derived and distributed with the assistance of the network. A root credential is configured in the remote UE and the network. The shared key is individually derived from the root credential by the remote UE and the network. The shared key is distributed by the AMF to the UE-to-Network relay.

AUSF derives the PC5 anchor key (e.g., sol #1, sol #15, sol #30, sol #39) used for PC5 keys derivation, based on the authentication vectors retrieved from UDM for Remote UE's authentication performed during PC5 link establishment.

Some embodiments herein may alternatively or additionally be described as addressing a key issue of authorization in the UE-to-Network relay scenario. In this regard, performing UE authentication during PC5 link establishment for the Remote UE independent to the UE's primary authentication of 3GPP access is supported. In some embodiments, the serving AMF of Remote UE should not be impacted for 5G-GUTI and UE context handling for the Remote UE. There is no need for the relay AMF to assign/maintain/refresh 5G-GUTI of Remote UE.

Some embodiments herein may alternatively or additionally be described as addressing a key issue of key management in 5G Proximity Services for UE-to-Network relay communication. In some embodiments, existing network entities (AMF, AUSF, UDM) are used for key derivation and distribution of keys used for UE-to-network relay communication. The security of the communication between UE-to-Network relay and remote UE is established based on a shared key which is derived and distributed with the assistance of the network. A root credential is configured in the remote UE and the network. The shared key is individually derived from the root credential by the remote UE and the network. The shared key is distributed by the AMF to the UE-to-Network relay. In some embodiments, the AUSF derives the PC5 anchor key used for PC5 keys derivation, based on the authentication vectors retrieved from UDM for Remote UE's authentication performed during PC5 link establishment.

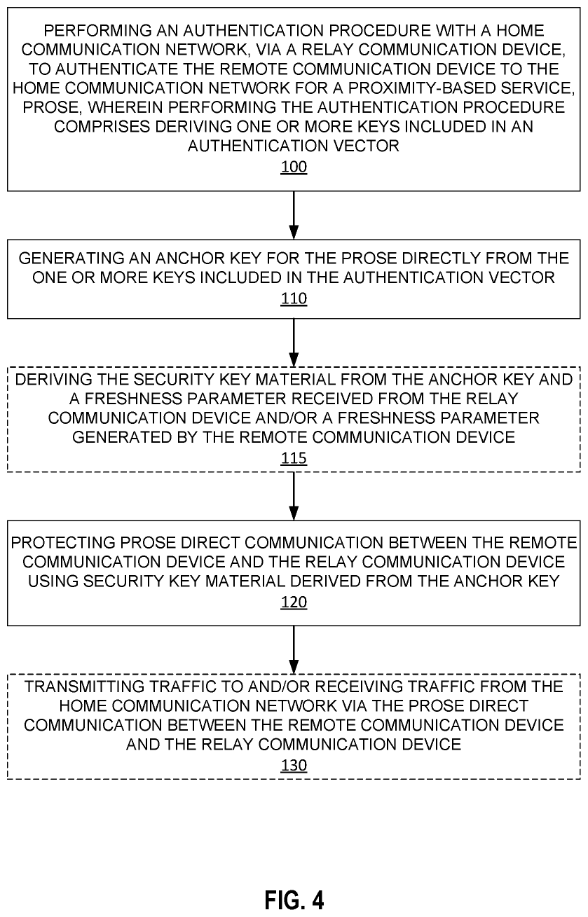

In view of the modifications and variations herein, FIG. 4 depicts a method performed by a remote communication device 12R according to some embodiments. The method comprises performing an authentication procedure 20 with a home communication network 10H, via a relay communication device 12Y, to authenticate the remote communication device 12R to the home communication network 10H for a proximity-based service, ProSe (Block 100). In this case, performing the authentication procedure 20 comprises deriving one or more keys 22K included in an authentication vector 22. The method also comprises generating an anchor key 26 for the ProSe directly from the one or more keys 22K included in the authentication vector 22 (Block 110), and protecting ProSe direct communication 11 between the remote communication device 12R and the relay communication device 12Y using security key material 32 derived from the anchor key 26 (Block 120).

In some embodiments, the authentication vector 22 is dedicated to the ProSe and/or the one or more keys 22K included in the authentication vector 22 are bound to the ProSe.

In some embodiments, deriving the one or more keys 22K included in the authentication vector 22 comprises deriving the one or more keys 22K as a function of a relay service code and/or an identity of a serving communication network 10S of the relay communication device 12R.

In some embodiments, the one or more keys 22K included in the authentication vector 22 include a cipher key and an integrity key.

In some embodiments, the method further comprises deriving the security key material 32 from the anchor key 26 and a freshness parameter received from the relay communication device 12Y and/or a freshness parameter generated by the remote communication device 12R (Block 115).

In some embodiments, the anchor key 26 is a PC5 anchor key K_{pc5} for a PC5 interface between the remote communication device 12R and the relay communication device 12Y.

In some embodiments, the authentication procedure 20 is performed as part of a connection establishment procedure for establishing a connection between the remote communication device 12R and the relay communication device 12Y. In one or more of these embodiments, the method further comprises generating an identity that identifies the anchor key 26, identifies the security key material 32, or temporarily identifies the remote communication device 12R, and after release of the connection, transmitting the identity to the same or a different relay communication device as part of a subsequent connection establishment procedure for establishing a new connection between the remote communication device 12R and the same or a different relay communication device. The method further comprises, based on the identity, reusing the anchor key 26 or the security key material 32 for re-authentication of the remote communication device 12R and/or for protecting ProSe direct communication over the new connection. In one or more of these embodiments, the method further comprises refraining from generating a home network root key as part of the authentication procedure 20 and/or as part of the connection establishment procedure. In one or more of these embodiments, the home network root key is a key KAUSF.

In some embodiments, the authentication procedure 20 to authenticate the remote communication device 12R to the home communication network 10H for the ProSe is independent of and/or separate from a primary authentication procedure for primary authentication of the remote communication device 12R to the home communication network 10H.

In some embodiments, the method further comprises transmitting traffic to and/or receiving traffic from the home communication network 10H via the ProSe direct communication 11 between the remote communication device 12R and the relay communication device 12Y (Block 130).

In some embodiments, the relay communication device is a Layer-3 UE-to-Network Relay.

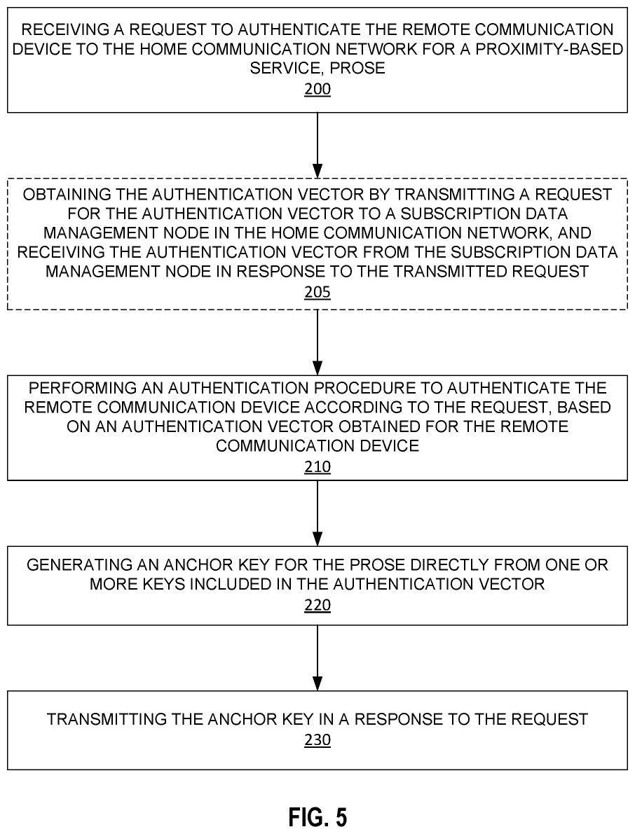

FIG. 5 depicts a method performed by a home network node 14H configured for use in a home communication network 10H of a remote communication device 12R. The method comprises receiving a request 18 to authenticate the remote communication device 12R to the home communication network 10H for a proximity-based service, ProSe (Block 200). The method further comprises performing an authentication procedure 20 to authenticate the remote communication device 12R according to the request 18, based on an authentication vector 22 obtained for the remote communication device 12R (Block 210). The method also comprises generating an anchor key 26 for the ProSe directly from one or more keys 22K included in the authentication vector 22 (Block 220), and transmitting the anchor key 26 in a response 28 to the request 18 (Block 230).

In some embodiments, the authentication vector 22 is dedicated to the ProSe and/or the one or more keys 22K included in the authentication vector 22 are bound to the ProSe.

In some embodiments, the one or more keys 22K included in the authentication vector 22 are a function of a relay service code and/or an identity of a serving communication network 10S from which the request 18 is received.

In some embodiments, the one or more keys 22K included in the authentication vector 22 include a cipher key and an integrity key.

In some embodiments, the anchor key 26 is a PC5 anchor key K_{pc5} for a PC5 interface.

In some embodiments, the authentication procedure 20 is performed as part of a connection establishment procedure for establishing a ProSe connection between the remote communication device 12R and a relay communication device 12Y. In one or more of these embodiments, the method further comprises generating an identity that identifies the anchor key 26. In this case, the response also includes the identity. In one or more of these embodiments, the method further comprises refraining from generating a home network root key as part of the authentication procedure 20 and/or as part of the connection establishment procedure. In one or more of these embodiments, the home network root key is a key KAUSF.

In some embodiments, the authentication procedure 20 to authenticate the remote communication device 12R to the home communication network 10H for the ProSe is independent of and/or separate from a primary authentication procedure for primary authentication of the remote communication device 12R to the home communication network 10H.

In some embodiments, the method further comprises obtaining the authentication vector 22 by transmitting a request 24 for the authentication vector 22 to a subscription data management node 14M in the home communication network 10H, and receiving the authentication vector 22 from the subscription data management node 14M in response to the transmitted request 24 (Block 205). In one or more of these embodiments, the transmitted request 24 indicates one or more of an identity associated with the remote communication device 12R, a relay service code, or a serving network name of a serving communication network 10S from which the request 18 is received.

In some embodiments, the request 18 is received from a serving network node 14S in a serving communication network 10S of a relay communication device 12Y that is to perform

ProSe direct communication 11 with the remote communication device 12R as part of relaying traffic between the remote communication device 12R and the home communication network 10H.

In one or more embodiments, the relay communication device 12Y is a Layer-3 UE-to-Network Relay.

In some embodiments, the request 18 includes a subscription concealed identifier of the remote communication device 12R. In this case, the method further comprises requesting de-concealment of the subscription concealed identifier in order to obtain a subscription permanent identifier of the remote communication device 12R, and the response 30 also includes the subscription permanent identifier.

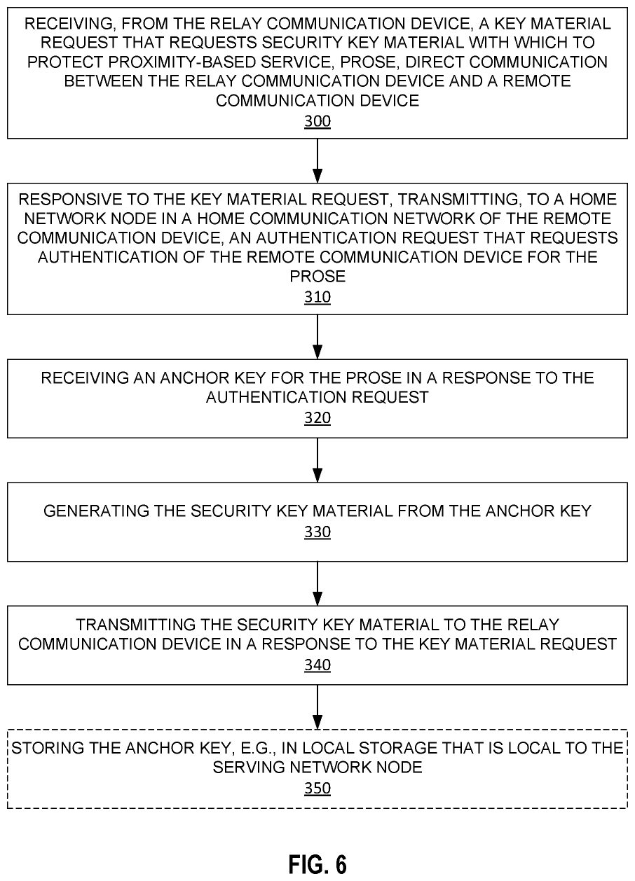

FIG. 6 shows a method performed by a serving network node 14S configured for use in a serving communication network 10S of a relay communication device 12R. The method comprises receiving, from the relay communication device 12R, a key material request 16 that requests security key material 32 with which to protect proximity-based service, ProSe, direct communication 11 between the relay communication device 12Y and a remote communication device 12R (Block 300). The method further comprises, responsive to the key material request 16, transmitting, to a home network node 14H in a home communication network 10H of the remote communication device 12R, an authentication request 18 that requests authentication of the remote communication device 12R for the ProSe (Block 310). The method further comprises receiving an anchor key 26 for the ProSe in a response 28 to the authentication request 18 (Block 320), generating the security key material 32 from the anchor key 26 (Block 330), and transmitting the security key material 32 to the relay communication device 12Y in a response 30 to the key material request 16 (Block 340).

In some embodiments, the authentication request 18 requests ProSe-specific authentication of the remote communication device 12R for the ProSe.

In some embodiments, the anchor key 26 is directly derived from one or more keys 22K included in an authentication vector 22 based on which the remote communication device 12R is authenticated for the ProSe. In one or more of these embodiments, the authentication vector 22 is dedicated to the ProSe and/or the one or more keys 22K included in the authentication vector 22 are bound to the ProSe. In one or more of these embodiments, the one or more keys 22K included in the authentication vector 22 are a function of a relay service code and/or an identity of the serving communication network 10S. In one or more of these embodiments, the one or more keys 22K included in the authentication vector 22 include a cipher key and an integrity key.

In some embodiments, the anchor key 26 is a PC5 anchor key K_{pc5} for a PC5 interface between the remote communication device 12R and the relay communication device 12Y. In some embodiments, the relay communication device 12Y is a Layer-3 UE-to-Network Relay.

In some embodiments, generating the security key material 32 comprises generating a freshness parameter and deriving the security key material 32 from the anchor key 26 and the freshness parameter. In one or more of these embodiments, the method further comprises transmitting the freshness parameter to the relay communication device 12Y.

In some embodiments, the method further comprises storing the anchor key 26, e.g., in local storage that is local to the serving network node 14S (Block 350). In one or more of these embodiments, the method further comprises, after transmitting the security key material 32 to the relay communication device 12Y, receiving a subsequent key material request that requests security key material with which to protect ProSe direct communication between the remote communication device 12R and the same or a different relay communication device, and responsive to the subsequent key material request, retrieving the anchor key 26 from the local storage. The method further comprises deriving new security key material from the anchor key 26, and transmitting the new security key material in a response to the subsequent key material request. In one or more of these embodiments, the method further comprises generating an identity that identifies the anchor key 26, identifies the security key material 32, or temporarily identifies the remote communication device 12R, and storing the anchor key 26 in the local storage in association with the identity. In this case, the subsequent key material request includes the identity, and the anchor key 26 is retrieved from the local storage using the identity included in the subsequent key material request.

In some embodiments, the method further comprises generating an identity that identifies the anchor key 26, identifies the security key material 32, or temporarily identifies the remote communication device 12R, and storing the anchor key 26 in the local storage in association with the identity. In one or more of these embodiments, storing the anchor key 26 comprises storing the anchor key in a context for the relay communication device 12Y or in a ProSe-specific context for the remote communication device 12R.

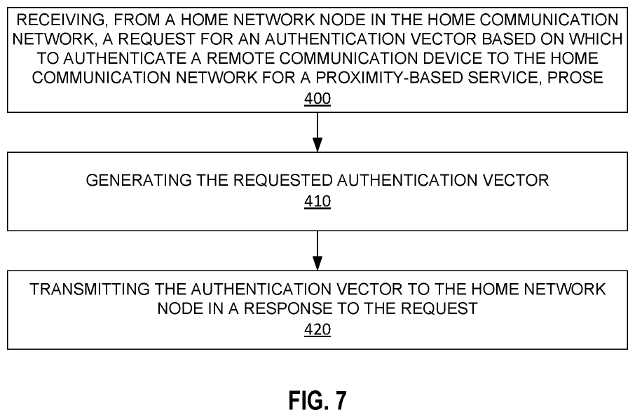

FIG. 7 shows a method performed by a subscription data management node 14M configured for use in a home communication network 10H of a remote communication device 12R. The method comprises receiving, from a home network node 14H in the home communication network 10H, a request 24 for an authentication vector 22 based on which to authenticate a remote communication device 12R to the home communication network 10H for a proximity-based service, ProSe (Block 400). The method also comprises generating the requested authentication vector 22 (Block 410), and transmitting the authentication vector 22 to the home network node 14H in a response to the request 24 (Block 420).

In some embodiments, the request 24 indicates one or more parameters. In this case, generating the authentication vector 22 comprises generating the authenticated vector 22 based on the one or more parameters. In some embodiments, the one or more parameters include one or more of: an identity associated with the remote communication device 12R, a relay service code, a serving network name of a serving communication network 12S serving a relay communication device 12Y that is to perform ProSe direct communication with the remote communication device 12R as part of relaying traffic between the remote communication device 12R and the home communication network 10H.

In some embodiments, the method further comprises assigning a sequence number of the authentication vector 22 specific to the ProSe.

In some embodiments, the authentication vector 22 is dedicated to the ProSe and/or one or more keys 22K included in the authentication vector 22 are bound to the ProSe.

In some embodiments, one or more keys 22K included in the authentication vector 22 are a function of a relay service code and/or an identity of a serving communication network 21S serving a relay communication device 12Y that is to perform ProSe direct communication with the remote communication device 12R as part of relaying traffic between the remote communication device 12R and the home communication network 10H.

Embodiments herein also include corresponding apparatuses. Embodiments herein for instance include a remote communication device 12R configured to perform any of the steps of any of the embodiments described above for the remote communication device 12R.

Embodiments also include a remote communication device 12R comprising processing circuitry and power supply circuitry. The processing circuitry is configured to perform any of the steps of any of the embodiments described above for the remote communication device 12R. The power supply circuitry is configured to supply power to the remote communication device 12R.

Embodiments further include a remote communication device 12R comprising processing circuitry. The processing circuitry is configured to perform any of the steps of any of the embodiments described above for the remote communication device 12R. In some embodiments, the remote communication device 12R further comprises communication circuitry.

Embodiments further include a remote communication device 12R comprising processing circuitry and memory. The memory contains instructions executable by the processing circuitry whereby the remote communication device 12R is configured to perform any of the steps of any of the embodiments described above for the remote communication device 12R.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the remote communication device 12R. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node configured to perform any of the steps of any of the embodiments described above for the home network node 14H, serving network node 14S, or subscription data management node 14M.

Embodiments also include a network node comprising processing circuitry and power supply circuitry. The processing circuitry is configured to perform any of the steps of any of the embodiments described above for the home network node 14H, serving network node 14S, or subscription data management node 14M. The power supply circuitry is configured to supply power to the network node.

Embodiments further include a network node comprising processing circuitry. The processing circuitry is configured to perform any of the steps of any of the embodiments described above for the home network node 14H, serving network node 14S, or subscription data management node 14M. In some embodiments, the network node further comprises communication circuitry.

Embodiments further include a network node comprising processing circuitry and memory. The memory contains instructions executable by the processing circuitry whereby the network node is configured to perform any of the steps of any of the embodiments described above for the home network node 14H, serving network node 14S, or subscription data management node 14M.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

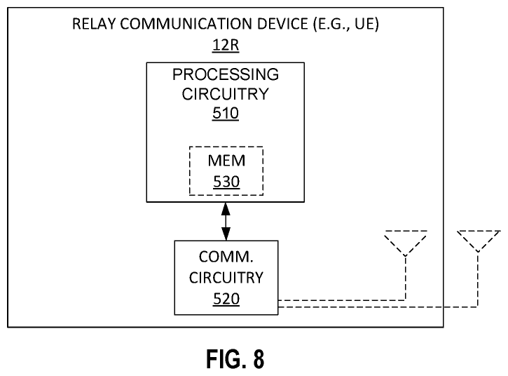

FIG. 8 for example illustrates a relay communication device 12R as implemented in accordance with one or more embodiments. As shown, the relay communication device 12R includes processing circuitry 510 and communication circuitry 520. The communication circuitry 520 (e.g., radio circuitry) is configured to transmit and/or receive information to and/or from one or more other nodes, e.g., via any communication technology. Such communication may occur via one or more antennas that are either internal or external to the relay communication device 12R. The processing circuitry 510 is configured to perform processing described above, e.g., in FIG. 4, such as by executing instructions stored in memory 530. The processing circuitry 510 in this regard may implement certain functional means, units, or modules.

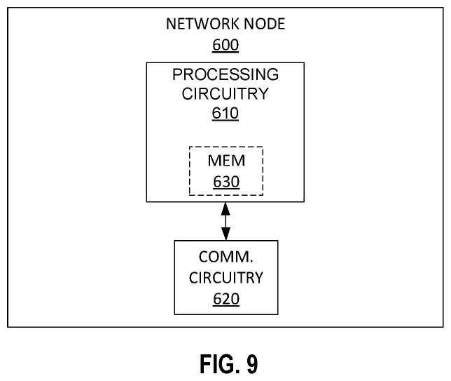

FIG. 9 illustrates a network node 600 as implemented in accordance with one or more embodiments. The network node 600 may be or exemplify the home network node 14H, serving network node 14S, or subscription data management node 14M. As shown, the network node 600 includes processing circuitry 610 and communication circuitry 620. The communication circuitry 620 is configured to transmit and/or receive information to and/or from one or more other nodes, e.g., via any communication technology. The processing circuitry 610 is configured to perform processing described above, e.g., in FIG. 5, 6, or 7, such as by executing instructions stored in memory 630. The processing circuitry 610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

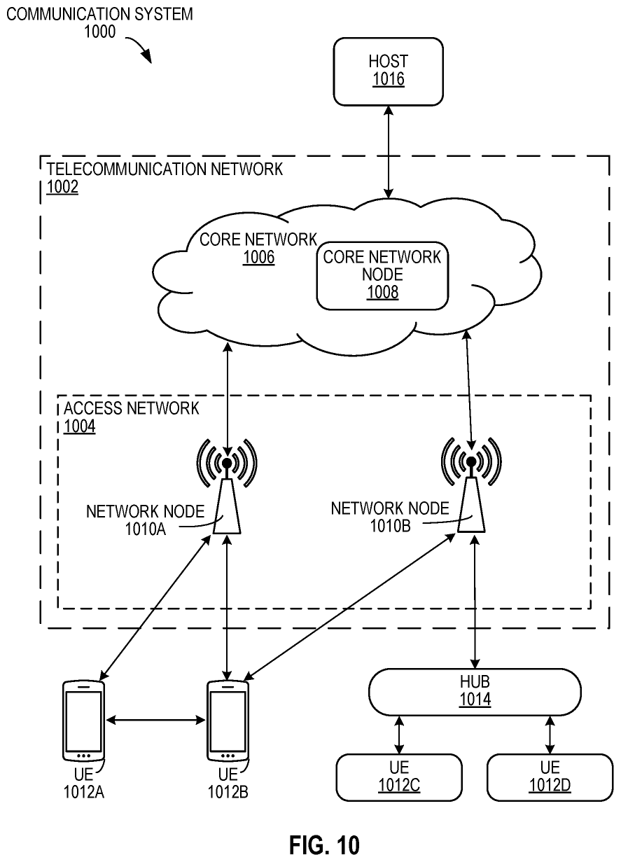

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management

Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

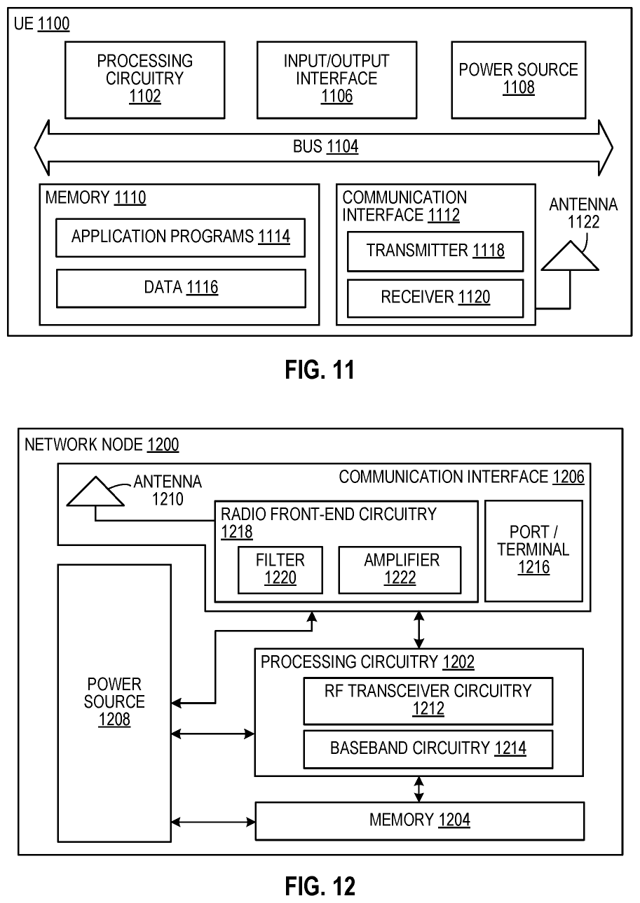

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE. A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification

(RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

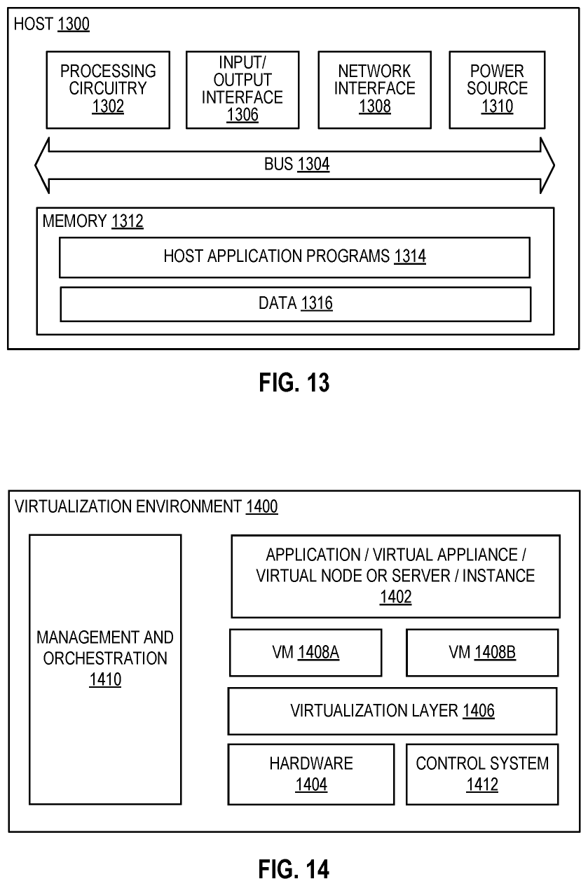

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

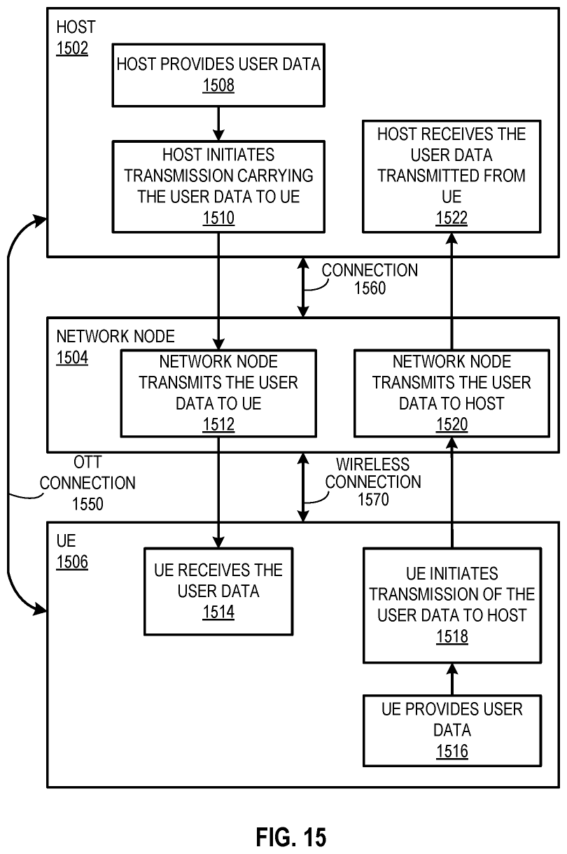

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a remote communication device, comprising:
performing an authentication procedure with a home communication network, via a relay communication device, to authenticate the remote communication device to the home communication network for a proximity-based service, ProSe, wherein performing the authentication procedure comprises deriving one or more keys included in an authentication vector;
generating an anchor key for the ProSe directly from the one or more keys included in the authentication vector; and
protecting ProSe direct communication between the remote communication device and the relay communication device using security key material derived from the anchor key.

2. The method of claim 1, wherein the authentication vector is dedicated to the ProSe and/or the one or more keys included in the authentication vector are bound to the ProSe.

3. The method of claim 1, wherein deriving the one or more keys included in the authentication vector comprises deriving the one or more keys as a function of a relay service code and/or an identity of a serving communication network of the relay communication device.

4. The method of claim 1, wherein the one or more keys included in the authentication vector include a cipher key and an integrity key.

5. The method of claim 1, further comprising deriving the security key material from:
the anchor key; and
a freshness parameter received from the relay communication device and/or a freshness parameter generated by the remote communication device.

6. The method of claim 1, wherein the anchor key is a PC5 anchor key K_{pc5} for a PC5 interface between the remote communication device and the relay communication device.

7. The method of claim 1, wherein the authentication procedure is performed as part of a connection establishment procedure for establishing a connection between the remote communication device and the relay communication device.

8. The method of claim 7, further comprising:
generating an identity that identifies the anchor key, identifies the security key material, or temporarily identifies the remote communication device; and
after release of the connection, transmitting the identity to the same or a different relay communication device as part of a subsequent connection establishment procedure for establishing a new connection between the remote communication device and the same or a different relay communication device; and
based on the identity, reusing the anchor key or the security key material for re-authentication of the remote communication device and/or for protecting ProSe direct communication over the new connection.

9-13. (canceled)

14. A method performed by a home network node configured for use in a home communication network of a remote communication device, the method comprising:
receiving a request to authenticate the remote communication device to the home communication network for a proximity-based service, ProSe;
performing an authentication procedure to authenticate the remote communication device according to the request, based on an authentication vector obtained for the remote communication device;
generating an anchor key for the ProSe directly from one or more keys included in the authentication vector; and
transmitting the anchor key in a response to the request.

15. The method of claim 14, wherein the authentication vector is dedicated to the ProSe and/or the one or more keys included in the authentication vector are bound to the ProSe.

16. The method of claim 14, wherein the one or more keys included in the authentication vector are a function of a relay service code and/or an identity of a serving communication network from which the request is received.

17. The method of claim 14, wherein the one or more keys included in the authentication vector include a cipher key and an integrity key.

18-57. (canceled)

58. A remote communication device, comprising:
processing circuitry, memory and transceiver circuitry collectively configured to perform operations comprising:
performing an authentication procedure with a home communication network, via a relay communication device, to authenticate the remote communication device to the home communication network for a proximity-based service, ProSe, wherein performing the authentication procedure comprises deriving one or more keys included in an authentication vector;
generating an anchor key for the ProSe directly from the one or more keys included in the authentication vector; and
protecting ProSe direct communication between the remote communication device and the relay communication device using security key material derived from the anchor key.

59. The remote communication device of claim 58, wherein the authentication vector is dedicated to the ProSe and/or the one or more keys included in the authentication vector are bound to the ProSe.

60. The remote communication device of claim 58, wherein deriving the one or more keys included in the authentication vector comprises deriving the one or more keys as a function of a relay service code and/or an identity of a serving communication network of the relay communication device.

61. The remote communication device of claim 58, wherein the one or more keys included in the authentication vector include a cipher key and an integrity key.

62. The remote communication device of claim 58, wherein the operations further comprise deriving the security key material from:
the anchor key; and
a freshness parameter received from the relay communication device and/or a freshness parameter generated by the remote communication device.

63. A home network node configured for use in a home communication network of a remote communication device, comprising:
processing circuitry, memory and transceiver circuitry collectively configured to perform operations comprising:
receiving a request to authenticate the remote communication device to the home communication network for a proximity-based service, ProSe;
performing an authentication procedure to authenticate the remote communication device according to the request, based on an authentication vector obtained for the remote communication device;
generating an anchor key for the ProSe directly from one or more keys included in the authentication vector; and
transmitting the anchor key in a response to the request.

64. The home network node of claim 63, wherein the authentication vector is dedicated to the ProSe and/or the one or more keys included in the authentication vector are bound to the ProSe.

65. The home network node of claim 63, wherein the one or more keys included in the authentication vector are a function of a relay service code and/or an identity of a serving communication network from which the request is received.

66. The home network node of claim 63, wherein the one or more keys included in the authentication vector include a cipher key and an integrity key.
